(19) United States
(12) Patent Application Publication
(10) Pub. No.: US 2026/0072193 A1
(43) Pub. Date: Mar. 12, 2026

(54) MULTI-WELL-BASED INTERWELL LOGGING COMMUNICATION SYSTEM

(71) Applicants: CHINA PETROLEUM & CHEMICAL CORPORATION, Beijing (CN); SINOPEC OILFIELD SERVICE CORPORATION, Beijing (CN); SINOPEC MATRIX CORPORATION, Qingdao, Shandong (CN); GEOSTEERING & LOGGING RESEARCH INSTITUTE, SINOPEC MATRIX CORPORATION, Qingdao, Shandong (CN)

(72) Inventors: Yongsheng CHAO, Qingdao, Shandong (CN); Defu ZANG, Qingdao, Shandong (CN); Tongzheng GUO, Qingdao, Shandong (CN); Yongli JI, Qingdao, Shandong (CN); Shouwei ZHANG, Qingdao, Shandong (CN); Yongping YAN, Qingdao, Shandong (CN)

(21) Appl. No.: 19/110,857

(22) PCT Filed: Sep. 14, 2023
(86) PCT No.: PCT/CN2023/118823

§ 371 Date: Mar. 12, 2025

(30) Foreign Application Priority Data
Sep. 14, 2022 (CN) 202211116504.0

(51) Int. Cl. G01V 1/44; H04B 7/185

(52) U.S. Cl. CPC G01V 1/44; H04B 7/18539; G01V 2200/12

(57) ABSTRACT

A multiwell-based interwell logging communication system has a central station and a plurality of satellite stations. The central station has a mobile base station, a central terminal, a ground transmitter for establishing an information transmission link between the central station and each satellite station via broadcast through the mobile base station and the central terminal, a downhole transmitter for receiving a basic beacon signal transmitted from the ground, completing transmission operation in interwell logging based on the basic beacon signal, and realizing communication and control inside a transmitting well in the interwell logging. Each of the satellite stations has a satellite station terminal on the ground, a ground receiver and a downhole receiver. The ground receiver is in point-to-point communication with the ground transmitter through the satellite station terminal so as to control the downhole receiver. The downhole receiver completes reception and collection operations in the interwell logging.

### TECHNICAL FIELD

The present invention relates to the technical field of mining geophysical well logging, and specifically to a multiwell-based interwell logging communication system.

### TECHNICAL BACKGROUND

Conventional logging technologies, whether electromagnetic logging, nuclear logging or acoustic logging technologies, are all centered on single well. The measurement of single well has limited detection depth, and is only able to reflect information on the formation around the wellbore, rather than the information on the distribution of oil, gas and water in regional or interwell formations. Therefore, it can only provide one-sided information. Interwell, multiwell measurement with three-dimensional imaging, however, is of great significance in effectively overcoming the above defects.

In the development of oil fields, the processes such as water injection, polymer injection and fracturing will inevitably bring major changes to the formations, especially the regional and interwell formations. Meanwhile, there will be significant changes in the formation and the oil, gas and water therein during the development of oil and gas. It has always been a perplexing problem in the industry as to how to monitor these changes. Currently, the interwell, multiwell measurement with three-dimensional imaging is an effective method to solve this problem.

The multiwell measurement with three-dimensional imaging technology represents a major trend in the development of logging, making a significant breakthrough in the existing measurement technology. As a new generation of measurement technology indispensable in the early, middle and late stages of oil field exploration and development, as well as an effective means for increasing unconventional oil and gas development, it plays an important role in increasing oil field reserves and production, providing detailed oil reservoir description, reducing cost, increasing efficiency, and optimizing development processes.

Many countries have carried out researches on multiwell measurement with three-dimensional imaging technology. However, the existing technologies are mostly software processing-based technologies that complete three-dimensional distribution and evaluation of oil, gas and geological bodies based on single well, well distribution and analysis of geophysical exploration data. The measurement results obtained in this manner are less accurate and precise than those of direct measurement.

Therefore, a solution is needed that can address the problem of lacking a transitional scale between single well measurement (third scale) and geophysical exploration (first scale) in the existing technologies.

### SUMMARY OF THE INVENTION

In view of the above technical problems, the present invention proposes a multiwell-based interwell logging communication system, which comprises a central station and a plurality of satellite stations, wherein the central station comprises a mobile base station and a central terminal; a ground transmitter, for establishing an information transmission link between the central station and each satellite station via broadcast through the mobile base station and the central terminal; and a downhole transmitter, for receiving a basic beacon signal transmitted from the ground, completing, controlled by the ground transmitter, transmission operation in interwell logging based on the basic beacon signal, and realizing communication and control inside a transmitting well in the interwell logging; and each of the satellite stations comprises a satellite station terminal on the ground; a ground receiver; and a downhole receiver, wherein the ground receiver is configured to be in point-to-point communication with the ground transmitter through the satellite station terminal, so as to control the downhole receiver, and the downhole receiver is configured to complete, controlled by the ground receiver, reception and collection operations in the interwell logging, and realize communication and control inside a receiving well in the interwell logging.

Preferably, the central station is located in a central position of a polygon formed by the plurality of satellite stations, wherein the ground transmitter is configured to transmit broadcast information containing different types of notification; and the ground receiver is configured to receive the broadcast information, obtain notification information relating to the receiving well associated therewith, and transmit feedback information from a current satellite station to the central station.

Preferably, the central station is further provided with a ground receiver, wherein the ground receiver at the central station or each satellite station is further configured to transmit a first time signal extracted by a high-precision time module arranged in the ground receiver, as the basic beacon signal, to a downhole device through a communication cable, thereby actuating the downhole device to complete interwell measurement communication and intrawell communication.

Preferably, the ground receiver comprises a BDS/GPS receiver, wherein the ground receiver is further configured to generate a corresponding system master clock after the basic beacon signal is transmitted, so that the communication and control in each well can be realized based on the system master clock.

Preferably, the ground receiver is further configured to receive a satellite time reference signal, which is converted by the high-precision time module into a low-frequency transmission beacon and a high-frequency transmission beacon, wherein the low-frequency transmission beacon is taken as the basic beacon signal.

Preferably, the ground receiver is further configured to perform shaping and driving on the extracted basic beacon signal, in order to transmit the processed basic beacon signal to the downhole device through the communication cable.

Preferably, an information transmission-communication link between the ground transmitter and the ground receiver is a wireless data link.

Preferably, the basic beacon signal is configured to transmit a synchronous transmission-reception pulse beacon and a synchronous communication pulse beacon in a time-sharing manner according to a preset sequence and alternating time intervals in a fixed period, wherein a cable communication module and a signal reception-collection module in the downhole transmitter or the downhole receiver are configured to perform beacon counting on the basic beacon signal respectively to determine a type of a current basic beacon signal according to counting results, based on which a first working mode and a second working mode of a current downhole device are determined, so that the first working mode is controlled to be executed while the second working mode is disabled.

Preferably, the downhole transmitter or the downhole receiver is further configured to determine, when the type of the current beacon signal is the synchronous transmission-reception pulse beacon, that the first working mode is an interwell measurement communication and data-collection mode, and the second working mode is a ground communication mode.

Preferably, the downhole transmitter or the downhole receiver is further configured to determine, when the type of the current beacon signal is the synchronous communication pulse beacon, that the first working mode is the ground communication mode, and the second working mode is the interwell measurement communication and data-collection mode.

Preferably, the downhole transmitter or the downhole receiver is further configured to determine, according to a current counting result and in combination with numbers of synchronous transmission, reception and communication for different functional phases, a real-time functional mode of the current downhole device, based on which the type of the current basic beacon signal is determined.

Preferably, the central station and each satellite station are configured to complete preparation procedure for communication collaboration in the interwell logging according to the following steps:

generating, by the ground receiver in the central station, the basic beacon signal required for the interwell logging, and actuating, by the ground transmitter, the mobile base station and the central terminal;

sending, by the ground transmitter, a first type of broadcast information for notifying each satellite station to prepare for multiwell logging through the mobile base station and the central terminal, and transmitting to the downhole transmitter a first type of notification information representing preparation for starting the interwell measurement communication and data-collection mode, in order to prepare for the multiwell logging;

completing preparation by the downhole transmitter, and notifying the ground transmitter, waiting for feedback information from each receiving well;

obtaining and decoding, by each ground receiver, the first type of broadcast information based on the basic beacon signal generated independent of the ground receiver of the central station in advance, and transmitting to the downhole receiver the notification information representing preparation for starting the interwell measurement communication and data-collection mode, in order to prepare for the multiwell logging;

completing preparation by each downhole receiver, and notifying the ground receiver; and

transmitting, by each ground receiver, to the ground transmitter the feedback information representing that the current receiving well has completed the preparation for the multiwell logging in a time-sharing manner, in order to start measurement operation of the communication collaboration in the interwell logging.

Preferably, the central station and each satellite station are configured to complete the measurement operation of the communication collaboration in the interwell logging according to the following steps:

sending, by the ground transmitter, a second type of broadcast information notifying each satellite station of starting reception operation in the interwell measurement through the mobile base station and the central terminal, and transmitting to the downhole transmitter a second type of notification information representing a start of transmission operation in the interwell measurement;

starting, by the downhole transmitter, transmission, collection and communication operations relating to the communication and control of the transmitting well in the interwell measurement;

obtaining and decoding, by each ground receiver, the second type of broadcast information based on the basic beacon signal generated independent of the ground receiver of the central station in advance, and transmitting to the downhole receiver notification information representing a start of the reception operation in the interwell measurement; and

starting, by each downhole receiver, reception, collection, data processing and communication operations relating to the communication and control of the receiving well in the interwell measurement, in order to complete multiwell measurement of all wells.

Preferably, the central station and each satellite station are configured to stop the measurement operation of the communication collaboration in the interwell logging according to the following steps:

sending, by the ground transmitter, a third type of broadcast notifying each satellite station to stop the measurement operation through the mobile base station and the central terminal after completing the multiwell measurement of all wells, and transmitting to the downhole transmitter a third type of notification information representing a completion of transmission;

stopping the transmission of the downhole transmitter, and notifying the ground transmitter;

receiving and decoding, by each ground receiver, the third type of broadcast based on the basic beacon signal generated independent of the ground receiver of the central station in advance, and transmitting to the downhole receiver the notification information representing the stop of the measurement operation; and

stopping the reception of each downhole receiver, and notifying the ground receiver after the reception is completed.

Preferably, the broadcast information includes transmission address, reception address, beacon type and transmission frequency, wherein the beacon type includes alignment mark, transmission preparation, completion of transmission preparation, transmitting well measurement, completion of logging transmission, reception preparation, completion of reception preparation, receiving well measurement and completion of logging reception.

Preferably, the system further comprises an imaging device connected to the ground transmitter and each ground receiver, and configured to obtain logging transmission data and logging reception data for each receiving well, based on which a three-dimensional imaging model for interwell measurement is constructed.

Preferably, the imaging device is further configured to convert the logging transmission data and the logging reception data into a logging data matrix, based on which two-dimensional imaging calculation is performed for each receiving well, in order to obtain the three-dimensional imaging model for interwell measurement after interpolation on calculation results.

Preferably, the imaging device is further configured to perform, according to two-dimensional profile resistivity distribution data of the receiving well, global and local electromagnetic induction calculation, and compare calculation results with the logging data matrix, in order to determine whether the two-dimensional imaging calculation is completed.

Preferably, the imaging device is arranged in the central station or any one of the satellite stations.

Compared with the prior arts, one or more of the embodiments in the above technical solutions have the following advantages or advantageous effects.

The present invention proposes a multiwell-based interwell logging communication system, which can perform three-dimensional imaging on geological bodies of the oil field area based on multiwell measurement, analyze and evaluate the distribution of oil and gas, and calculate the reserves precisely. Therefore, the logging communication system has wide application and promising prospect in oil field exploration and development. Firstly, the three-dimensional geological body imaging model constructed based on the interwell measurement according to the present invention can effectively describe and analyze the distribution of oil, gas and water, and locate the oil and gas enrichment areas, thereby significantly improving the effectiveness of well drilling and reducing blind investment. Secondly, the imaging model obtained according to the present invention is an effective means to monitor the procedures of oil field development (including the procedures of water injection and steam injection, and the front and direction thereof) efficiently, which is of great significance in optimizing the oil field injection and production scheme, improving the recovery rate of crude oil, and effectively improving the output ratio. Thirdly, the imaging model obtained according to the present invention is a high and new technology for effective high-precision regional detection and evaluation. Thus, the present invention can overcome the weakness of insufficient lateral detection capability in existing logging technologies, and expand the logging range from one well to multiple wells, (say, from tens of centimeters to thousands of meters), thus achieving a qualitative leap in logging technology, significantly enhancing the ability to describe reservoir characteristics and improving the success rate of oil field rolling exploration.

Other features and advantages of the present invention will be set forth in the description which follows, and, in part, will be apparent from the description, or may be learned from the implementation of the present invention. The objective and other advantages of the present invention may be realized and attained from the structure particularly pointed out in the description, claims and drawings.

### BRIEF DESCRIPTION OF THE DRAWINGS

The accompanying drawings are used to provide a further understanding on the present invention, and constitute a part of the description. Together with the embodiments of the present invention, the drawings are intended to explain the present invention, but not constitute any limitation to the present invention. In the drawings:

FIG. 1 schematically shows an overall structure of a multiwell-based interwell logging communication system according to embodiments of the present application;

FIG. 2 schematically shows a detailed structure of the multiwell-based interwell logging communication system according to embodiments of the present application;

FIG. 3 schematically shows internal operations of ground devices and downhole devices in the multiwell-based interwell logging communication system according to embodiments of the present application;

FIG. 4 is a flow diagram schematically showing intrawell communication and control in the multiwell-based interwell logging communication system according to embodiments of the present application;

FIG. 5 is a flow diagram schematically showing communication collaboration in multiwell measurement implemented by the multiwell-based interwell logging communication system according to embodiments of the present application;

FIG. 6 is a timing flow diagram schematically showing basic time beacons of a central station and each satellite station in the multiwell-based interwell logging communication system according to embodiments of the present application;

FIG. 7 schematically shows three-dimensional cylinder measurement data and a two-dimensional resistivity profile model in the multiwell-based interwell logging communication system according to embodiments of the present application; and

FIG. 8 schematically shows principles of global induction calculation and local scattering calculation in the multiwell-based interwell logging communication system according to embodiments of the present application.

### DETAILED DESCRIPTION OF EMBODIMENTS

The implementation mode of the present invention will be explained in detail with reference to the embodiments and the accompanying drawings, whereby it can be fully understood how to solve the technical problem by the technical means according to the present invention, implement the technical solution, and achieve the technical effects thereof. It should be noted that all the embodiments and the technical features defined therein may be combined together if there is no conflict, and the technical solutions obtained in this manner shall all fall within the scope of protection of the present invention.

In addition, the steps illustrated in the flow chart in the drawings can be performed in a computer system containing a set of computer-executable instructions. Moreover, although a logical sequence is shown in the flow chart, in some cases these steps as shown or described may be performed in an order different than that shown herein.

Conventional logging technologies, whether electromagnetic logging, nuclear logging or acoustic logging technologies, are all centered on single well. The measurement of single well has limited detection depth, and is only able to reflect information on the formation around the wellbore, rather than the information on the distribution of oil, gas and water in regional or interwell formations. Therefore, it can only provide one-sided information. Interwell, multiwell measurement with three-dimensional imaging, however, is of great significance in effectively overcoming the above defects.

In the development of oil fields, the processes such as water injection, polymer injection and fracturing will inevitably bring major changes to the formations, especially the regional and interwell formations. Meanwhile, there will be significant changes in the formation and the oil, gas and water therein during the development of oil and gas. It has always been a perplexing problem in the industry as to how to monitor these changes. Currently, the interwell, multiwell measurement with three-dimensional imaging is an effective method to solve this problem.

The multiwell measurement with three-dimensional imaging technology represents a major trend in the development of logging, making a significant breakthrough in the existing measurement technology. As a new generation of measurement technology indispensable in the early, middle and late stages of oil field exploration and development, as well as an effective means for increasing unconventional oil and gas development, it plays an important role in increasing oil field reserves and production, providing detailed oil reservoir description, reducing cost, increasing efficiency, and optimizing development processes.

Many countries have carried out researches on multiwell measurement with three-dimensional imaging technology. However, the existing technologies are mostly software processing-based technologies that complete three-dimensional distribution and evaluation of oil, gas and geological bodies based on single well, well distribution and analysis of geophysical exploration data. The measurement results obtained in this manner are less accurate and precise than those of direct measurement.

In view of the above technical problems, the present invention proposes a multiwell-based interwell logging communication system, which comprises a single well-based cable logging communication system formed between a ground device (including a ground transmitter and a ground receiver) and a logging device. Specifically, the receiving/transmitting and collection functions of the downhole device as well as the cable communication function are turned on and off through beacon signals, in order to reduce the interference of the logging cable communication on the weak received signals. When the signals are transmitted, received and collected, the cable communication is turned off, while the transmitting, receiving, and collection functions are turned off during the cable communication, in order to ensure that the two modes do not interfere with each other. Hence, the collection quality of extremely weak signals in the multiwell measurement can be ensured. Further, the interwell logging communication system represents a breakthrough compared to single well-based measurement. With a centralized satellite-station network model comprising a transmitting well as a center and multiple receiving wells, the interwell logging communication system realizes multiwell cooperation through wireless communication and thus three-dimensional collection of formation measurement data, thus achieving deep and long-distance three-dimensional imaging of formation information, and obtaining three-dimensional precise description of underground oil reservoir distribution.

Therefore, the multiwell-based interwell logging communication system according to the present invention is reliable and convenient to operate, which can significantly reduce the interference of the logging cable communication on the weak received signals, and realize multiwell cooperation and three-dimensional imaging. Thus, according to the present invention, the gap between single well measurement (third scale) and geophysical exploration (first scale) can be effectively filled up through direct measurement, i.e., multiwell measurement (second scale).

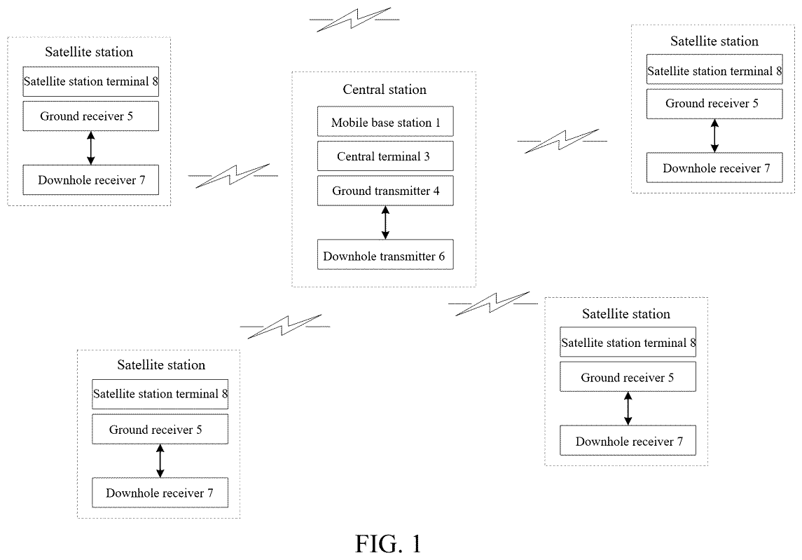

FIG. 1 schematically shows an overall structure of a multiwell-based interwell logging communication system according to embodiments of the present application. As shown in FIG. 1, the interwell logging communication system (hereinafter referred to as “logging communication system”) according to the embodiments of the present invention includes a central station A and a plurality of satellite stations B, wherein the central station A is located in a median or central position of a polygon formed by the plurality of satellite stations B. The central station A is provided at a position where a transmitting well for multiwell logging (interwell logging) is located, and the satellite stations B are provided at positions where receiving wells for the multiwell logging (interwell logging) are located respectively.

As shown in FIG. 1, the central station A includes a ground transmitter 4, a mobile base station 1, a central terminal 3, and a downhole transmitter 6. The mobile base station 1 and the central terminal 3 are both provided on the ground transmitter 4. The downhole transmitter 6 is in communication with the ground transmitter 4. The downhole transmitter 6 is configured to receive basic beacon signals transmitted from the ground, complete, based on a current basic beacon signal, the transmission operation in the interwell logging under the control of the ground transmitter 4, and realize the communication and control operations for the transmitting well in the interwell logging. The satellite station B includes a ground receiver 5, a satellite station terminal 8, and a downhole receiver 7, wherein the satellite station terminal 8 is provided on the ground receiver 5, and the downhole receiver 7 is in communication with the ground receiver 5. The downhole receiver 7 is configured to complete reception and collection operations in the interwell logging under the control of the ground receiver 5, and realize communication and control inside the receiving well in the interwell logging.

Further, the ground transmitter 4 is configured to establish an independent information transmission link between the central station and each satellite station via broadcast through the mobile base station 1 and the central terminal 3. The ground receiver 5 is configured to be in point-to-point communication with the ground transmitter 4 through the satellite station terminal 8, so as to control the downhole receiver 7.

In the embodiments of the present invention, the ground transmitter 4 cooperates with the downhole transmitter 6 to complete the transmission operation in the interwell logging. In addition, the ground transmitter 4 and the downhole transmitter 6 can also provide an interwell logging transmission source for each satellite station B, and communicate with each satellite station B. The ground receiver 5 cooperates with the downhole receiver 7 to complete the reception and collection operations for signals transmitted by the central station, and communicates with the central station A.

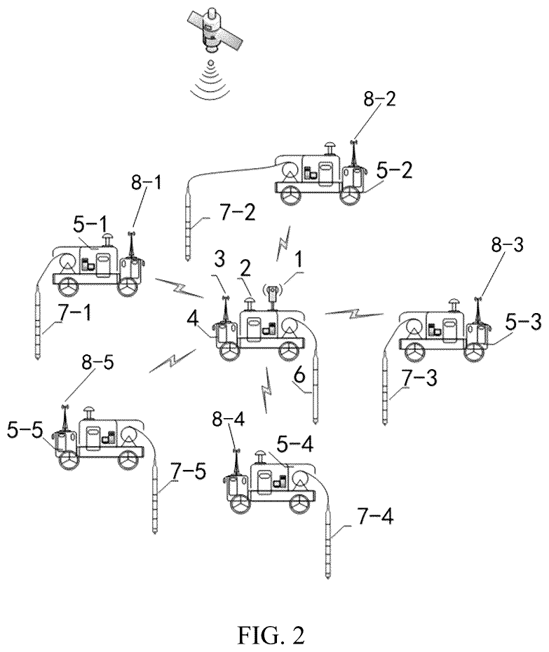

FIG. 2 schematically shows a detailed structure of the multiwell-based interwell logging communication system according to embodiments of the present application. Referring to FIG. 2, the ground transmitter 4 and the downhole transmitter 6 are arranged at a transmitting well, and other wells (receiving wells) are respectively provided with a ground receiver 5-1, a downhole receiver 7-1, a ground receiver 5-2, a downhole receiver 7-2, . . . , a ground receiver 5-n, and a downhole receiver 7-n.

With the transmitting well as a center, a wireless mobile base station 1, a wireless mobile terminal 3, and a BDS/GPS high-precision ground receiver 2 (see below) are arranged at the ground transmitter 4, thus forming a central mobile base station. Each receiving well is marked as a satellite station in a corresponding position. A wireless mobile terminal 8 and a BDS/GPS high-precision ground receiver 5 (see below) are arranged at the ground receiver 5. The receiving wells and the transmitting well together form a star-shaped wireless mobile network.

Meanwhile, the ground transmitter 4 and the downhole transmitter 6 complete the transmission operation (for signals such as acoustic wave and electromagnetic wave) in interwell communication and measurement, and the ground receiver 5 and the downhole receiver 7 complete the receiving operation (for signals such as acoustic wave and electromagnetic wave) in the interwell communication and measurement. The ground transmitter 4 is configured to provide transmission energy and control as well as transmission signals (acoustic wave, electromagnetic wave, etc.) for the downhole transmitter 6, and receive the collected and monitored signals uploaded by the downhole transmitter 6. The ground receiver 5 provides control and energy supply for the downhole receiver 7. The downhole receiver 7 is configured to receive and collect signals such as acoustic waves and electromagnetic waves transmitted by the downhole transmitter 6 through the formation, and then upload the collected signals to the ground receiver 5.

Specifically, the ground transmitter 4 in the transmitting well transmits high-frequency wireless electromagnetic waves through the wireless mobile base station 1. In other wells (the transmitting well and the receiving wells), the wireless mobile terminal 3 receives the high-frequency electromagnetic waves from the transmitting well, thereby establishing wireless communication and collaborative data links for the multiwell-based logging. The ground transmitter 4 is arranged in a median or central position of the receiving wells.

Further, the wireless mobile base station 1 and the wireless mobile terminal 3 are arranged on the ground transmitter 4 at the transmitting well, and the wireless mobile terminal 8 is arranged on the ground receiver 5 at each receiving well. Thus a wireless network link between the transmitting well and each receiving well is formed, thereby establishing a virtual star-shaped network. The transmitting well is the central control node in the star-shaped network, and the receiving wells are the satellite station nodes in the star-shaped network.

Further, the ground transmitter 4 transmits information through broadcast, sending instructions, parameters and other information to each ground receiver 5. Each receiver 5 adopts point-to-point communication mode. Any one of the receivers 5 is only in independent two-way communication with the transmitter 4, but with no communication with any other receiver.

Further, when the ground transmitter 4 is in independent communication with the ground receiver 5, the ground transmitter 4 in the embodiments of the present invention is configured to transmit broadcast information containing different types of notifications. The ground transmitter 4 is also configured to provide transmission energy for the downhole transmitter 6, control the downhole transmitter 6, and receive the information collected by the downhole transmitter 6. The ground receiver 5 is configured to receive the broadcast information from the ground transmitter, and obtain notification information related to the receiving well associated with the ground receiver 5, in order to perform internal (intrawell) communication and measurement operations for the receiver according to the received notification. The ground receiver 5 is further configured to transmit, after the internal (intrawell) communication and measurement operations for the receiver are completed according to the received notification, information that needs to be fed back by the corresponding satellite station to the ground transmitter 4 of the central station, in order to receive the measured and collected information from the downhole receiver 7 and control the same.

Further, in the embodiments of the present invention, a ground receiver 2 (i.e., central receiver 2) is provided at the central station, in order to facilitate the communication between the ground transmitter 4 and the ground receiver 5. The ground receiver 2 is arranged on the ground transmitter 4. The ground receiver 5 at the receiving well and the ground receiver 2 at the transmitting well each comprise a BDS receiver or GPS (high-precision) receiver. Further, a first time signal is extracted as the basic beacon signal by a high-precision time module 10 arranged in the ground receivers 2 and 5, which is transmitted to the downhole devices 6 and 7 (downhole transmitter or downhole receiver) through a communication cable, thereby actuating the downhole devices 6 and 7 to complete interwell and intrawell communication necessary for the interwell logging. The intrawell communication includes the communication between the ground transmitter 4 and the downhole transmitter 6 inside the transmitting well, and between the ground receiver 5 and the downhole receiver 7 inside the receiving well.

Specifically, each of the transmitters and the receivers is provided with a BDS/GPS high-precision ground receiver. The high-precision time module 10 receives and converts a satellite standard time signal into a low-frequency transmission beacon and a high-frequency transmission beacon. The low-frequency transmission beacon is taken as the basic beacon signal, and the current low-frequency transmission beacon is taken as the first time signal, thus generating the basic beacon signals for the transmitter 4 and the receiver 5. Then, the ground receivers 2 and 5 are further configured to derive, after the basic beacon signals are generated, a system master clock for each well (the transmitting well and each receiving well), based on which the communication in each well can be realized. Thus, after generating the system master clocks between the ground transmitter 4 and the downhole transmitter 6, and between the ground receiver 5 and the downhole receiver 7, the transmission, collection, control, communication and collaboration of the ground transmitter 4 and the ground receiver 5 are all based on the basic beacon signals and the system master clocks.

In addition, the ground receivers 2 and 5 are further configured to shape and drive the extracted basic beacon signals, thereby transmitting the processed basic beacon signals to the downhole devices 6 and 7 (downhole transmitter or downhole receiver) through the communication cable.

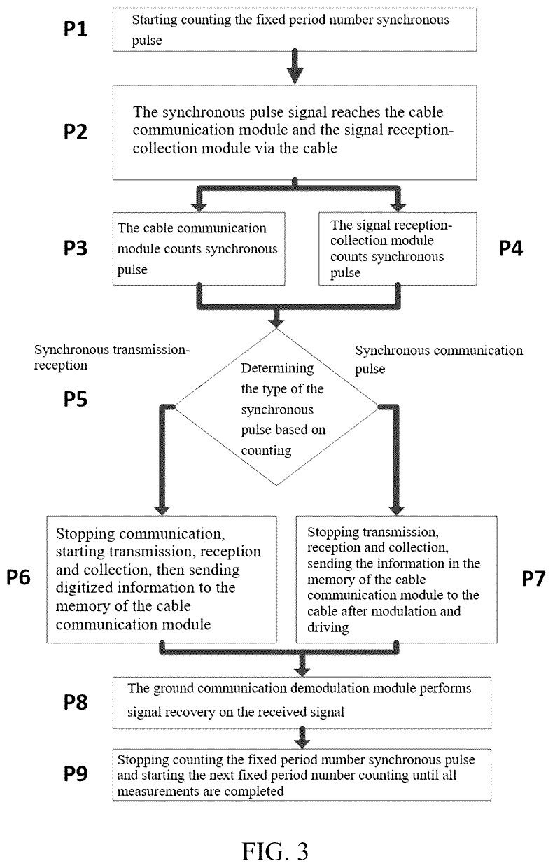

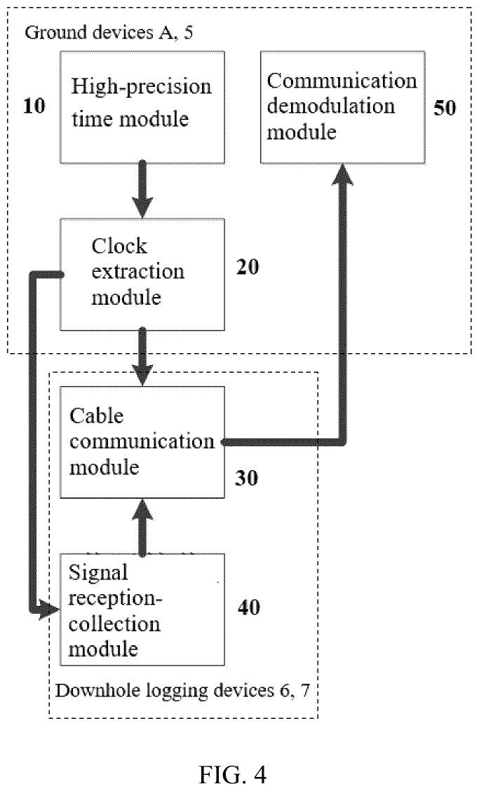

FIG. 3 schematically shows internal operations of the ground devices and the downhole devices in the multiwell-based interwell logging communication system according to embodiments of the present application. FIG. 4 is a flow diagram schematically showing intrawell communication and control in the multiwell-based interwell logging communication system according to embodiments of the present application. The intrawell communication procedures in the embodiments of the present invention will be described below in combination with FIGS. 3 and 4. It should be noted that for the intrawell communication of the transmitting well, the ground device required is a transmitting-end ground device A integrated with the ground transmitter 4 and the ground receiver 5, and the downhole (logging) device is the downhole transmitter 6. Meanwhile, for the intrawell communication of each receiving well, the ground device required is the ground receiver 5, and the downhole (logging) device is the downhole receiver 7.

In intrawell communication, the downhole devices 6 and 7 first receive the basic beacon signals transmitted from the ground. In actual interwell logging technology, the ground devices 4 and 5 are in communication with the downhole devices 6 and 7 respectively through the communication cable. The downhole devices 6 and 7 will receive the basic beacon signals transmitted from the ground devices 4 and 5 respectively through the communication cable. The basic beacon signal is configured to transmit a synchronous transmission-reception pulse beacon and a synchronous communication pulse beacon in a time-sharing manner according to a preset sequence and alternating time intervals in a fixed period.

In the embodiments of the present invention, a fixed period refers to a period of mutual information transmission and data collection between the ground devices 4 and 5 and the downhole logging devices 6 and 7 (i.e., a period from starting a new cycle by the ground devices 4 and 5 to receiving the measured data from the downhole devices 6 and 7 and completing data recovery). In a fixed period, the ground devices 6 and 7 continuously transmit basic beacon signals to the downhole devices. More specifically, in a fixed period, the ground devices 4 and 5 will transmit the synchronous transmission-reception pulse beacon (i.e., control instruction for performing transmission or reception operation based on synchronous pulse beacon) and the synchronous communication pulse beacon (i.e., communication instruction based on synchronous pulse beacon) to the downhole logging devices 6 and 7 in a time-sharing manner through the communication cable according to the preset sequence and the preset alternating time intervals.

In one embodiment, in a fixed period the synchronous communication pulse beacon and the synchronous transmission-reception pulse beacon are transmitted in a time-sharing manner, wherein the synchronous communication pulse beacon is first transmitted for a first time period and then the synchronous transmission-reception pulse beacon is transmitted for a second time period, the fixed period consisting of the first time period and the second time period. In another embodiment, in a fixed period the synchronous communication pulse beacon and the synchronous transmission-reception pulse beacon are transmitted in a time-sharing manner, wherein the synchronous communication pulse beacon is first transmitted for a first time period and then the synchronous transmission-reception pulse beacon is transmitted for a second time period, with the above sequence being repeated continuously.

Further, when the downhole logging devices 6 and 7 continuously receive the basic beacon signals, both a cable communication module 30 and a signal reception-collection module 40 in the downhole logging devices 6 and 7 perform beacon counting on the basic beacon signals received in real time. Then, the type of the current basic beacon signal is determined according to counting results of the two modules. When determining the type of the beacon signal, both the cable communication module 30 and the signal reception-collection module 40 perform pulse counting on the basic beacon signals respectively received thereby in real time. Next, whether the current basic beacon signal is the synchronous communication pulse signal or the synchronous transmission-reception pulse signal is determined according to the counting results of the two modules 30 and 40.

Next, the downhole transmitter 6 or the downhole receiver 7 is further configured to determine, according to the current signal type, a first working mode and a second working mode corresponding to the downhole transmitter 6 or the downhole receiver 7 by the cable communication module 30 arranged therein. Then, the first working mode is controlled to be executed while the second working mode is disabled. In the embodiments of the present invention, the first working mode is a mode corresponding to the current signal type. The second working mode is another working mode of the downhole logging devices other than the first working mode.

In the embodiments of the present invention, there are two working modes for the downhole logging devices 6 and 7. One of the working modes is an interwell measurement communication and data-collection mode, in which the current downhole logging device is in communication with other downhole logging devices arranged at other downhole positions for interwell measurement and communication (such as interwell acoustic logging, acoustic remote-detection logging), so as to collect the transmitted logging data (i.e., the transmission and reception between the downhole transmitter 6 and the downhole receivers 7 in different orientations). The other working mode refers a ground communication mode, in which the current downhole logging device is in communication with the ground devices 4 and 5 through the communication cable (i.e., the direct communication between the downhole devices and the ground).

In one embodiment, the downhole transmitter 6 or the downhole receiver 7 is further configured to determine, when the current beacon signal is the synchronous communication pulse beacon signal, that the first working mode is the ground communication mode while the second working mode is the interwell measurement communication and data-collection mode. Thus, the current first working mode is controlled to be executed while the second working mode is disabled. In this case, the downhole logging devices 6 and 7 are only in communication with the ground devices 4 and 5, but do not collect the logging data corresponding to the downhole communication.

In another embodiment, the downhole transmitter 6 or the downhole receiver 7 is further configured to determine, when the current beacon signal is the synchronous transmission-reception pulse beacon signal, that the first working mode is interwell measurement communication and data-collection mode while the second working mode is the ground communication mode. Thus, the current first working mode is controlled to be executed while the second working mode is disabled. In this case, the downhole transmitter 6 is only in communication with other downhole devices (e.g., the downhole receiver 7) for interwell measurement, but not in communication with the ground devices.

Therefore, the embodiments of the present invention propose an intrawell communication method for extremely weak signals based on cable logging. With the basic beacon signal as the synchronous control signal for switching between the reception-collection mode and the cable communication mode, the adverse effect of cable logging communication on signal reception and collection are effectively reduced, thereby improving the quality of weak signal reception and collection in multiwell measurement or communication.

The intrawell communication for cable logging according to the embodiments of the present invention will be illustrated as follows in detail with reference to FIGS. 3 and 4.

Before the measurement is initiated, in step P0 (not shown), the receivers 4 and 5 extract from the high-precision time module 10 the basic beacon signals, which are transmitted to the downhole devices 6 and 7 through the communication cable. In the embodiments of the present invention, the ground devices A and 5 are each provided with a clock extraction module 20 and the high-precision time module 10. Written with extraction rules of the basic beacon signal, the clock extraction module 20 can extract the basic beacon signal that can transmit the synchronous transmission-reception pulse beacon and the synchronous communication pulse beacon in a time-sharing manner within a fixed period according to the preset sequence and the alternating time intervals. Thus, in step P0 the clock extraction module 20 in each of the ground devices A and 5 extracts the basic beacon signal that meets the preset rules from the high-precision time module 10, and then transmits the extracted basic beacon signal to the downhole device 6 or 7 through the communication cable, thus moving on to step P1. The basic beacon signal refers to a signal that transmits the synchronous transmission-reception pulse beacon and the synchronous communication pulse beacon in a time-sharing manner within a fixed period according to the preset sequence and the alternating time intervals. In the embodiments of the present invention, the high-precision time module 10 is preferably a GPS/BDS time service module.

In addition, step P0 also performs shaping and cable driving on the extracted basic beacon signals, according to the embodiments of the present invention. Then, the processed basic beacon signals are transmitted to the downhole logging devices, in order to ensure that they can be received by the downhole cable communication module 30 and the signal reception-collection module 40.

In Step P1, the current fixed period starts, and the ground devices A and 5 perform beacon counting on the basic beacon signals extracted in step P0, thus moving on to step P2. In step P2, the downhole logging devices 6 and 7 receive the basic beacon signals transmitted from the ground. The basic beacon signals reach the cable communication module 30 and the signal reception-collection module 40 in each of the downhole logging devices 6 and 7 through the communication cable. In step P3, the cable communication module 30 performs beacon counting on the basic beacon signal received thereby in real time. In step P4, the signal reception-collection module 40 simultaneously performs beacon counting on the basic beacon signal received thereby in real time. In step P5, the cable communication module 30 determines whether the currently received basic beacon signal is the synchronous transmission-reception pulse beacon signal or the synchronous communication pulse beacon signal according to the beacon counting results of the cable communication module 30 and the signal reception-collection module 40.

Specifically, in step P5, the cable communication module 30 and the signal reception-collection module 40 in each of the downhole logging devices 6 and 7 perform beacon counting on the basic beacon signals. In combination with the synchronous transmitting number, the synchronous reception beacon number, and the synchronous communication beacon number in different functional phases, a real-time functional mode of the current downhole devices 6 and 7 is determined, based on which the beacon signal type can be further determined correspondingly. In the embodiments of the present invention, since the basic beacon signal refers to a signal that transmits synchronous transmission-reception pulse beacon and synchronous communication pulse beacon in a time-sharing manner according to the preset sequence and alternating time intervals in a fixed period, the downhole logging devices 6 and 7 usually have multiple functional phases, namely a transmission phase, a reception phase, and a synchronous communication phase. The time of each functional phase refers to the time of a corresponding fixed number of synchronous beacons (wherein the number of synchronous beacons corresponding to one of different functional phases matches a respective one of said alternating time intervals). When the real-time counting result reaches the synchronous beacon number of the transmission phase, the reception phase or the synchronous communication phase, the current functional phase of the downhole logging device can be determined. When the downhole logging device is in the transmission phase or the reception phase, the type of the current pulse signal is the synchronous transmission-reception pulse beacon. When the downhole logging device is in the synchronous communication phase, the type of the current pulse signal is the synchronous communication pulse beacon.

Further, when the current signal is a synchronous transmission-reception pulse beacon signal, step P5 is completed to move on to step P6. The cable communication module 30 determines that the current first working mode is the interwell measurement communication and data-collection mode, while the current second working mode is the ground communication mode. Next, a first data volume collected in the current interwell measurement and communication (the measurement and communication between the current downhole logging device and other downhole logging devices, i.e., the measurement and communication between the downhole transmitter 6 and the downhole receivers 7 in different orientations) is digitized, the result of which is sent to a memory within the cable communication module 30 for downhole storage, thus buffering the collected first data volume. In step P6, the cable communication module 30 controls the downhole logging devices 6 and 7 to stop communicating with the ground devices A and 5, and also controls the signal reception-collection module 40 in each of the current downhole devices 6 and 7 for measurement or communication with other downhole logging devices, in order to control the transmission, reception, and collection relating to the interwell logging. After that, the digitized signals collected in real time (for example, the electromagnetic wave signals detected by the downhole receiver) are sent to the memory in the cable communication module 30, thus buffering the collected logging information.

Further, when the current signal is the synchronous communication pulse beacon signal, step P5 is completed to move on to step P7. The cable communication module 30 determines that the current first working mode is the ground communication mode, while the current second working mode is the interwell measurement communication and data-collection mode. Next, modulating and cable driving are performed on the data stored in the downhole devices 6 and 7. The processed information is transmitted to the ground through the cable. In step P7, the cable communication module 30 controls the signal reception-collection module 40 in each of the downhole logging devices 6 and 7 to stop transmission, reception, and collection, and performs modulating and cable driving on the logging information cached in the memory of the cable communication module 30. Subsequently, the logging information after modulating and cable driving is transmitted to the ground devices A and 5 through the communication cable, thus moving on to step P8.

In step P8, a communication demodulation module 50 in each of the ground devices A and 5 is configured to receive and recover the logging information transmitted from the downhole devices through the communication cable. Then in step P9, the beacon counting for the basic beacon signal in the current fixed period stops. Thus the current fixed period ends to move on to a next fixed period, in which case step P9 is followed by step P1 of the next fixed period, starting the counting on the basic beacon signal in said next fixed period, until all measurement operations are completed.

As shown in FIG. 3, the downhole logging devices 6 and 7 according to the embodiments of the present invention each include the signal reception-collection module 40 and the cable communication module 30. The signal reception-collection module 40 is configured to receive the basic beacon signal transmitted from the ground, perform beacon counting thereon, and then send the counting result and the collected data as received to the cable communication module 30. The basic beacon signal refers to a signal that transmits the synchronous transmission-reception pulse beacon and the synchronous communication pulse beacon in a time-sharing manner within a fixed period according to the preset sequence and the alternating time intervals. The cable communication module 30 is configured to receive the basic beacon signal synchronously with the signal reception-collection module 40, perform pulse counting thereon, and determine the type of the current basic beacon signal according to the two counting results. Then, the first working mode and the second working mode corresponding to the current logging device are determined according to the type of the signal. Finally, the downhole devices are controlled to execute the first working mode, while the second working mode is disabled.

Further, the cable communication module 30 is further configured to determine, when the current signal is the synchronous transmission-reception pulse beacon signal, that the current first working mode is the interwell measurement communication and data-collection mode, while the current second working mode is the ground communication mode. Next, the first data volume collected in the current interwell measurement and communication is digitized, the result of which is sent to the memory within the cable communication module 30 for downhole storage.

Further, the cable communication module 30 is further configured to determine, when the current signal is the synchronous communication pulse beacon signal, that the current first working mode is the ground communication mode, while the current second working mode is the interwell measurement communication and data-collection mode. Next, modulating and cable driving are performed on the stored data. Then, the processed data is transmitted to the ground through the cable.

Further, each of the ground devices A and 5 according to the embodiments of the present invention includes the high-precision time module 10, the clock extraction module 20, and the communication demodulation module 50. Specifically, the ground devices A and 5 are configured to extract the basic beacon signals from the high-precision time module 10 through the clock extraction module 20, transmit the basic beacon signals to the downhole devices 6 and 7 through the clock extraction module 20 via the communication cable, start the current fixed period, and perform beacon counting on the basic beacon signals. In addition, the communication demodulation module 50 in each of the ground devices A and 5 is configured to receive and recover the logging information transmitted from the downhole devices through the communication cable. In the embodiments of the present invention, the high-precision time module 10 is preferably a GPS/BDS time service module.

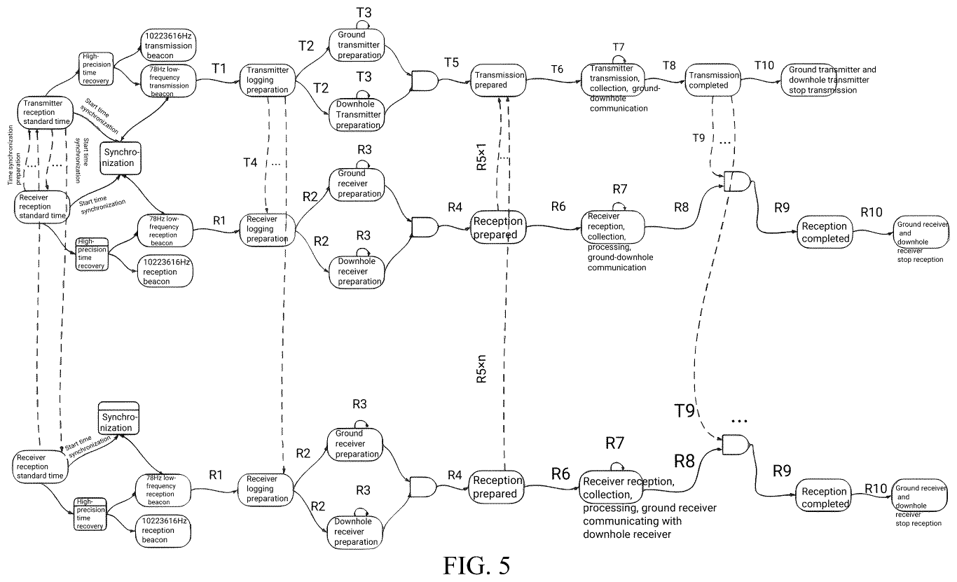

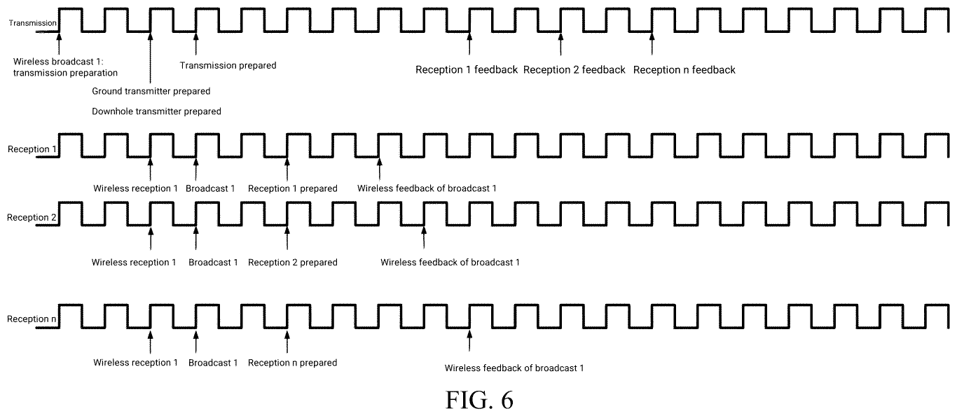

FIG. 5 is a flow diagram schematically showing communication collaboration in the multiwell measurement implemented by the multiwell-based interwell logging communication system according to embodiments of the present application. FIG. 6 is a timing flow diagram schematically showing basic time beacons of the central station and each satellite station in the multiwell-based interwell logging communication system according to embodiments of the present application. The communication procedures in the interwell logging according to the embodiments of the present invention will be described below in combination with FIGS. 5 and 6.

First, a preparation stage of the communication collaboration in the interwell logging is described as follows. The preparation procedures of the communication collaboration in the multiwell measurement between the central station and each satellite station are completed according to the following steps.

The ground receiver 2 in the central station generates the basic beacon signal (low-frequency transmission beacon) required for the interwell measurement, and the ground transmitter actuates the mobile base station 1 and the central terminal 3.

The ground transmitter 4 sends a first type of broadcast information notifying each satellite station to prepare for the multiwell logging through the mobile base station 1 and the central terminal 3, and transmits to the downhole transmitter 6 a first type of notification information representing that the interwell measurement communication and data-collection mode is ready to start, in order to prepare for the multiwell logging.

The downhole transmitter 6 completes the preparation for starting the multiwell logging and notifies the ground transmitter 4, waiting for feedback information from each receiving well.

Based on the basic beacon signal (low-frequency receiving beacon synchronously generated with the low-frequency transmission beacon) generated independent of the ground receiver 2 of the central station in advance, each ground receiver 5 obtains and decodes the first type of broadcast information, and transmits to the downhole receivers 7 the notification information representing the start of the interwell measurement communication and data-collection mode, in order to prepare for the multiwell logging.

Each downhole receiver 7 completes the preparation for starting the multiwell logging according to the current notification information, and notifies the ground receiver 5.

Each ground receiver 5 transmits to the ground transmitter 4 the feedback information representing that the current receiving well has completed the preparation for the multiwell logging in a time-sharing manner, in order to start the measurement operation of the communication collaboration in the multiwell measurement. At this time, all the devices involved in the multiwell logging have completed the preparations for the multiwell measurement.

It should be noted that, in the embodiments of the present invention, the low-frequency transmission beacon and the low-frequency receiving beacon are base points for the communication collaboration in the multiwell measurement, which work independently of each other but start timing synchronously.

Specifically, as shown in FIGS. 5 and 6, in Step S1 a high-precision time recovery module on the ground transmitter 4 converts the signal into a low-frequency transmission beacon signal (78 Hz) and a high-frequency transmission-collection beacon signal (10223616 Hz), which are output synchronously. The frequency (78 Hz) of the low-frequency transmission beacon signal is preferably as far as possible from the commercial power frequency, the generator frequency and the harmonics thereof. The frequency of the high-frequency transmission-collection beacon is preferably 2N times that of the low-frequency transmission beacon (wherein N is a positive integer, which is not limited in the embodiments of the present invention). Meanwhile, the BDS/GPS high-precision ground receiver 2 on the ground transmitter 4 is actuated to receive the satellite time reference signal. In this manner, the above low-frequency transmission beacon is taken as the basic beacon signal for controlling interwell and intrawell communication and measurement in the embodiments of the present invention.

In Step S2, the low-frequency transmission beacon signal, as a control baseline for the communication collaboration in the multiwell measurement, is transmitted to the downhole transmitter 6 as a reference for downhole transmission control and collection, and also used as a time-alignment base point for the transmitter 4 to control the receivers 5.

In Step S3, the ground transmitter 4 is warmed up for a period of time. After the low-frequency transmission beacon and the high-frequency transmission-collection beacon can both stably output, the preparation for the multiwell logging starts.

In Step S4, after T1 low-frequency transmission beacons, the preparation for transmission logging starts. The ground transmitter 4 actuates the wireless mobile base station 1 and the wireless mobile terminal 3. Then after T2 low-frequency transmission beacons, the actuations of the wireless mobile base station 1 and the wireless mobile terminal 3 are completed, waiting for the actuation of the ground transmitter 4 and the downhole transmitter 6.

In Step S5, the ground transmitter 4 broadcasts the notification of preparation for the multiwell logging (including preparation for transmission, and parameters such as transmission frequency) through the wireless mobile terminal 3, and notifies the downhole transmitter 6 of the preparation for the multiwell logging at the same time.

In Step S6 carried out in parallel with Step S5, after T3 low-frequency transmission beacons, the preparation of the downhole transmitter 6 is completed, for which the ground transmitter 4 is notified. Then, both the preparations of the ground transmitter 4 and the downhole transmitter 6 are completed, waiting for the feedback from the ground receiver 5.

In Step S7, after T4 low-frequency transmission beacons, each receiver receives a broadcast notification through the wireless mobile terminal 3, starting the preparation for the multiwell logging.

In Step S8, all the ground receivers 5, in synchronization with the transmitter 4, actuate the BDS/GPS high-precision ground receiver 2 on the ground receiver 5-n to receive the satellite time reference signal. Meanwhile, the high-precision time recovery module on the ground receiver 5-n converts the signal into the low-frequency receiving beacon signal (78 Hz) and the high-frequency reception-collection beacon signal (10223616 Hz), which are output synchronously. The ground receiver 5-n is warmed up for a period of time. After the low-frequency receiving beacon signal and the high-frequency reception-collection beacon signal can both stably output (after R1 low-frequency receiving beacons), the preparation for the multiwell logging is carried out. In this manner, the above low-frequency transmission beacon is used as the basic beacon signal in the embodiments of the present invention, for controlling the interwell and intrawell communication and measurement.

In Step S9, after R2 low-frequency receiving beacons, the receiver receives and decodes the broadcast information from the transmitter 4 through the wireless mobile terminal 3, and notifies the downhole receiver 7-n to start preparation for the multiwell logging.

In Step S10, after R3 low-frequency receiving beacons both the ground receiver 5-n and the downhole receiver 7-n are prepared, and after R4 low-frequency receiving beacons the preparation for reception is completed, which is fed back by the ground receiver to the ground transmitter 4 in a time-sharing manner.

In Step S11, after R5×1 low-frequency receiving beacons, the ground receiver 5-1 sends the feedback on the completion of the preparation to the ground transmitter 4 through the wireless mobile terminal 3; after R5×2 low-frequency receiving beacons, the ground receiver 5-2 sends the feedback on the completion of the preparation to the ground transmitter 4 through the wireless mobile terminal 3; . . . ; and after R5×n low-frequency receiving beacons, the ground receiver 5-n sends the feedback on the completion of the preparation to the ground transmitter 4 through the wireless mobile terminal 3.

Next, the logging stage of the communication collaboration in the interwell logging according to the embodiments of the present invention is described as follows. The measurement operations of the communication collaboration in the multiwell measurement between the central station and each satellite station are carried out according to the following steps.

The ground transmitter 4 sends a second type of broadcast information notifying each satellite station of starting reception operation in the interwell measurement through the mobile base station 1 and the central terminal 3, and transmits to the downhole transmitter 4 a second type of notification information representing the start of transmission operation in the interwell measurement.

Then the downhole transmitter 4 immediately starts the transmission, collection and communication operations relating to the intrawell communication and control of the transmitting well in the interwell logging.

Based on the basic beacon signal (low-frequency reception beacon generated in synchronization with the low-frequency transmission beacon) generated independent of the ground receiver 2 of the central station in advance, each ground receiver 5 receives and decodes the second type of broadcast information, and transmits to the downhole receiver 7 the notification information representing the start of the reception operation in the interwell measurement.

Each downhole receiver 7 starts the receiving, collection, data processing and communication operations relating to the intrawell communication and control of the receiving well in the interwell logging according to the current notification, in order to complete the multiwell measurement of all wells.

Specifically, as shown in FIGS. 5 and 6, in Step S12 after T5 low-frequency transmission beacons, the transmission operation of the transmitter 4 and the reception operation of the receiver 5 start according the feedback by the wireless mobile terminal 3 and the ground receiver 5.

Step S13 is similar to Steps S5 to S12. After T6 low-frequency transmission beacons, the transmitter 4 and the receiver 5 start transmission and reception operations synchronously. Meanwhile, the ground transmitter 4 and the downhole transmitter 6 start transmission, collection and communication operations, while the ground receiver 5 and the downhole receiver 7 start receiving, collection, processing and communication operations, until the measurement (logging) is completed for all wells. In addition, the logging transmission data is stored in the local ground transmitter 4 through the intrawell communication between the ground transmitter 4 and the downhole transmitter 6, and the logging reception data is stored in the local ground receiver 5 through the intrawell communication between the ground receiver 5 and the downhole receiver 7.

Thus, according to the embodiments of the present invention, three-dimensional geological imaging for the well-area (i.e., the interwell logging area formed by the transmitting well and the receiving wells) can be carried out based on the transmission data and reception data stored in the ground transmitter 4 and each ground receiver 5.

Finally, the stop of measurement operations of the communication collaboration in the interwell logging according to the embodiments of the present invention is described as follows. The measurement operations of the communication collaboration in the multiwell measurement between the central station and each satellite station are stopped according to the following steps.

After the multiwell measurement of all wells is completed, the ground transmitter 4 sends a third type of broadcast information notifying each satellite station to stop the measurement operation through the mobile base station 1 and the central terminal 3, and transmits to the downhole transmitter 6 a third type of notification information representing the completion of transmission.

Then, the downhole transmitter 6 stops transmission, and notifies the ground transmitter 4.

Based on the basic beacon signal generated independent of the ground receiver 2 of the central station in advance, each ground receiver 5 receives and decodes the third type of broadcast information, and transmits to the downhole receiver 7 the notification information representing the stop of the measurement operation.

Each downhole receiver 7 stops reception according to the current notification, and notifies the ground receiver 5 after the reception is completed.

Specifically, as shown in FIGS. 5 and 6, Step S14 is similar to Steps S5 to S12. After T7 low-frequency transmission beacons, the transmission is completed. After T9 low-frequency transmission beacons, the ground transmitter 4 notifies both the ground receiver 5-n and the downhole transmitter 6 to stop the measurement at the same time. After R9 low-frequency receiving beacons, the ground receiver 5-n and the downhole receiver 7-n stop reception. After T10 low-frequency transmission beacons, the ground transmitter 4 and the downhole transmitter 6 stop transmission.

Further, in the interwell logging communication system according to the embodiments of the present invention, the various broadcast information includes transmission address, reception address, beacon type and transmission frequency. For the effective control of the low-frequency transmission beacon and the low-frequency reception beacon, the beacons may be classified according to parameters and objects of the multiwell measurement, such as transmission frequency, sampling rate, etc. The information on beacon classification is included in the broadcast information of the transmitter 4, so that the transmitter 4 can notify each receiver 5. Thus in the embodiments of the present invention, the beacon type includes alignment mark, transmission preparation, completion of transmission preparation, transmitting well measurement, completion of logging transmission, reception preparation, completion of reception preparation, receiving well measurement, and completion of logging reception.

It should be noted that when the transmitter sends the broadcast information, the broadcast information can be configured according to the current phase of the multiwell logging, the distribution characteristics and object of the receiving wells, the precision of the logging data, the requirement for logging efficiency, etc. The broadcast information is not limited here.

Specifically, the reception address 00 indicates that the current receiving objects are all the receivers. The set of beacon type contains: No. 0 beacon alignment; No. 1 transmission preparation; No. 2 completion of transmission (completion of transmission preparation); No. 3 transmission, collection and ground-downhole communication (transmitting well measurement); No. 4 completion of transmission (completion of logging transmission); No. 5 reception preparation; No. 6 completion of reception (completion of reception preparation); No. 7 reception, collection, processing and ground-downhole communication (receiving well measurement); No. 8 completion of reception (completion of logging reception), etc., which represent nodes for various phases in the multiwell communication collaboration. No. 0 (“beacon alignment”) is performed only before the measurement or at fixed intervals (a multiple of the low-frequency transmission beacon), in order to ensure that the transmitter 4 and the receiver 5 start the low-frequency beacon simultaneously, thereby communicating with the downhole device simultaneously, and effectively ensuring a high level of consistency of transmission, reception, collection, control and processing.

To sum up, the transmission, reception, return of each broadcast information and the feedback of the downhole device in the embodiments of the present invention are all controlled by the transmitter 4 based on an integer multiple of the low-frequency beacon as the time reference. The transmission, reception, collection, control and processing relating to the ground-downhole communication are realized by independent low-frequency beacons generated by the corresponding ground transmitter 4 or the ground receiver 5, which send corresponding instructions to the downhole devices to realize intrawell control. Thus, in the interwell logging according to embodiments of the present invention, the reception of signals can be controlled by the transmission thereof, the downhole devices can be controlled by the ground devices, and the transmission and multiwell wireless communication can be controlled by time beacons.

In addition, the logging communication system according to the embodiments of the present invention further comprises an imaging device (not shown) arranged in the central station or any one of the satellite stations. The imaging device, which is connected to the ground transmitter 4 and each ground receiver 5, is configured to obtain the logging transmission data stored in the ground transmitter 4 and the logging reception data stored in each ground receiver 5, and construct a three-dimensional imaging model of the interwell measurement based on the logging transmission and reception data. Therefore, the imaging device according to the embodiments of the present invention can perform three-dimensional geological imaging on an interwell logging space formed by the transmitting well and the receiving wells.

In three-dimensional imaging, the imaging device is further configured to convert a data set including the logging transmission and reception data into a logging data matrix, based on which two-dimensional imaging calculation is performed for each receiving well. After interpolation on the calculation results, the three-dimensional imaging model of the interwell measurement can be obtained. Specifically, the imaging device first maps and combines the logging transmission data with the logging reception data of each receiving well respectively, in order to obtain multiple groups of logging data mᵢ. Then data interpolation and normalization are performed on each group of logging data to obtain an M×1 column vector for each group of logging data. Then, all the logging data are combined to form an M×N matrix m, wherein i denotes a serial number of the receiving wells, N denotes a total number of the receiving wells, and m denotes a group of logging data each including the logging transmission data and the logging reception data of a corresponding receiving well. Each group of logging data column vector corresponds to two-dimensional profile resistivity distribution data including the logging transmission data and the logging reception data of the current receiving well i.

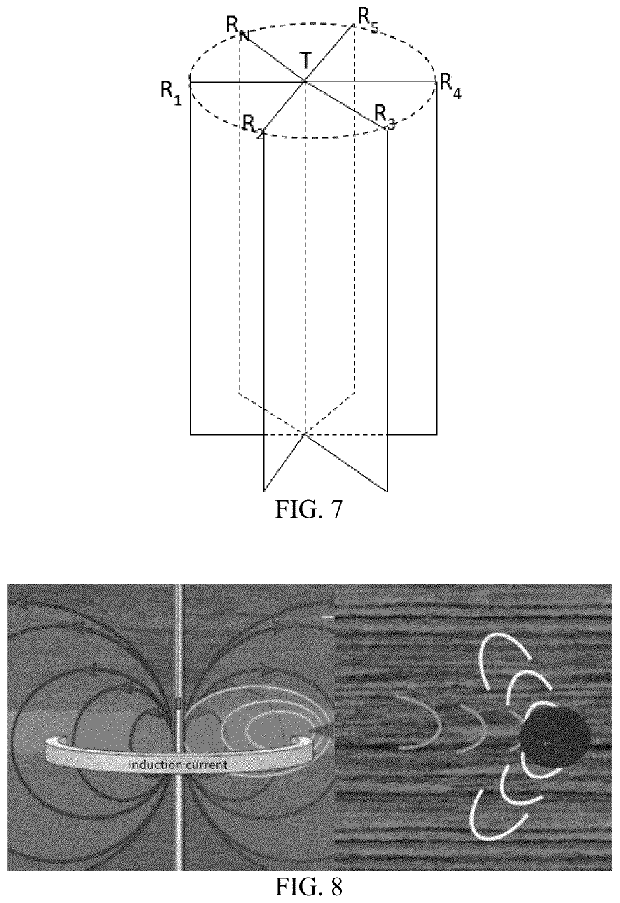

FIG. 7 schematically shows three-dimensional cylinder measurement data and a two-dimensional resistivity profile model in the multiwell-based interwell logging communication system according to embodiments of the present application. As shown in FIG. 7, the three-dimensional cylinder measurement data is cylindrical logging reception data formed based on the measurement reception data obtained by all the receiving wells, and the two-dimensional resistivity profile model is formed based on the groups of logging data.

Next, the imaging device is further configured to perform, according to the two-dimensional profile resistivity distribution data of the receiving wells, global and local electromagnetic induction calculations, and compare the calculation results with the logging data matrix, in order to determine whether the two-dimensional imaging calculation is completed.

FIG. 8 schematically shows principles of global induction calculation and local scattering calculation in the multiwell-based interwell logging communication system according to embodiments of the present application. After global electromagnetic induction calculation and local electromagnetic scattering calculation for each two-dimensional profile resistivity distribution data, the global induction data and local scattering data for each receiving well are obtained, thus completing a two-dimensional imaging calculation. Next, the global induction data (calculation result) and local scattering data (calculation result) of each receiving well are compared with the logging data of the corresponding group respectively. If the error is less than a set value, the calculation is terminated, otherwise the global induction and local scattering calculations continue, in order to perform interpolation calculation on the logging data of multiple receiving wells until the error meets the requirements of the set value.

The results of the global electromagnetic induction calculation can reflect the general distribution of the two-dimensional profile, but cannot reflect the precise information therein. However, fine structures in the profile can be recognized when the global electromagnetic induction calculation is combined with the local scattering calculation. Therefore, a three-dimensional imaging model can be obtained after the interpolation calculation on the two-dimensional profiles of multiple receiving wells.

Finally, the imaging device is further configured to perform interpolation on the two-dimensional resistivity profile between adjacent receiving wells after completing the global induction calculation and local scattering calculation of the two-dimensional profile, thereby obtaining said three-dimensional imaging model of the interwell measurement. The imaging resolution can be significantly improved by combining the global induction calculation with the local scattering calculation.

The present invention proposes a multiwell-based interwell logging communication system, which can perform three-dimensional imaging on geological bodies of the oil field area based on multiwell measurement, analyze and evaluate the distribution of oil and gas, and calculate the reserves precisely. Therefore, the logging communication system has wide application and promising prospect in oil field exploration and development. Firstly, the three-dimensional geological body imaging model constructed based on the interwell measurement according to the present invention can effectively describe and analyze the distribution of oil, gas and water, and locate the oil and gas enrichment areas, thereby significantly improving the effectiveness of well drilling and reducing blind investment. Secondly, the imaging model obtained according to the present invention is an effective means to monitor the procedures of oil field development (including the procedures of water injection and steam injection, and the front and direction thereof) efficiently, which is of great significance in optimizing the oil field injection and production scheme, improving the recovery rate of crude oil, and effectively improving the output ratio. Thirdly, the imaging model obtained according to the present invention is a high and new technology for effective high-precision regional detection and evaluation. Thus, the present invention can overcome the weakness of insufficient lateral detection capability in existing logging technologies, and expand the logging range from one well to multiple wells, (say, from tens of centimeters to thousands of meters), thus achieving a qualitative leap in logging technology, significantly enhancing the ability to describe reservoir characteristics and improving the success rate of oil field rolling exploration.

The foregoing is merely illustrative of preferred embodiments of the present invention, but the scope of protection of the present invention is not limited thereto. Any modifications or substitutions that can be readily conceived by one skilled in the art within the technical scope disclosed herein shall fall within the scope of protection of the present invention. Therefore, the scope of protection of the present invention should be determined according to the scope of protection of the claims.

It should be understood that the embodiments of the present invention are not limited to the specific structures, processing steps or materials disclosed herein, but should extend to equivalent substitutions of these features understood by one ordinarily skilled in the art. It should also be understood that the terminology used herein is for the purpose of describing a particular embodiment only, rather than being construed as restriction.

The phrase “an embodiment” or “embodiments” as mentioned in the description means that the particular features, structures or characteristics described in conjunction with the embodiment or embodiments are included in at least one embodiment of the present invention. Thus, the phrase “an embodiment” or “embodiments” used throughout the description does not necessarily refer to the same embodiment.

Although the embodiments of the present invention are described hereinabove, the disclosure is provided for facilitating to understand the implementing mode of the present invention, but rather restricting the present invention. Without departing from the spirit and scope of the present disclosure, one skilled in the art can make various modifications and improvements in forms and details of the implementing mode. The scope of protection of the present invention shall be determined by the appending claims.

1. A multiwell-based interwell logging communication system, comprising a central station and a plurality of satellite stations, wherein
the central station comprises:
a mobile base station and a central terminal;
a ground transmitter, for establishing an information transmission link between the central station and each satellite station via broadcast through the mobile base station and the central terminal; and
a downhole transmitter, for receiving a basic beacon signal transmitted from the ground, completing, controlled by the ground transmitter, transmission operation in interwell logging based on the basic beacon signal, and realizing communication and control inside a transmitting well in the interwell logging; and
each of the satellite stations comprises:
a satellite station terminal on the ground;
a ground receiver; and
a downhole receiver,
wherein the ground receiver is configured to be in point-to-point communication with the ground transmitter through the satellite station terminal, so as to control the downhole receiver, and the downhole receiver is configured to complete, controlled by the ground receiver, reception and collection operations in the interwell logging, and realize communication and control inside a receiving well in the interwell logging.

2. The system according to claim 1, characterized in that the central station is located in a central position of a polygon formed by the plurality of satellite stations,
wherein the ground transmitter is configured to transmit broadcast information containing different types of notification; and
the ground receiver is configured to receive the broadcast information, obtain notification information relating to the receiving well associated therewith, and transmit feedback information from a current satellite station to the central station.

3. The system according to claim 2, characterized in that the central station is further provided with a ground receiver, wherein the ground receiver at the central station or each satellite station is further configured to transmit a first time signal extracted by a high-precision time module arranged in the ground receiver, as the basic beacon signal, to a downhole device through a communication cable, thereby actuating the downhole device to complete interwell measurement communication and intrawell communication.

4. The system according to claim 3, characterized in that the ground receiver comprises a BDS/GPS receiver, wherein the ground receiver is further configured to generate a corresponding system master clock after the basic beacon signal is transmitted, so that the communication and control in each well can be realized based on the system master clock.

5. The system according to claim 3, characterized in that the ground receiver is further configured to receive a satellite time reference signal, which is converted by the high-precision time module into a low-frequency transmission beacon and a high-frequency transmission beacon, wherein the low-frequency transmission beacon is taken as the basic beacon signal.

6. The system according to claim 3, characterized in that the ground receiver is further configured to perform shaping and driving on the extracted basic beacon signal, in order to transmit the processed basic beacon signal to the downhole device through the communication cable.

7. The system according to claim 3, characterized in that an information transmission-communication link between the ground transmitter and the ground receiver is a wireless data link.

8. The system according to claim 3, characterized in that the basic beacon signal is configured to transmit a synchronous transmission-reception pulse beacon and a synchronous communication pulse beacon in a time-sharing manner according to a preset sequence and alternating time intervals in a fixed period,
wherein a cable communication module and a signal reception-collection module in the downhole transmitter or the downhole receiver are configured to perform beacon counting on the basic beacon signal respectively to determine a type of a current basic beacon signal according to counting results, based on which a first working mode and a second working mode of a current downhole device are determined, so that the first working mode is controlled to be executed while the second working mode is disabled.

9. The system according to claim 8, characterized in that the downhole transmitter or the downhole receiver is further configured to determine, when the type of the current beacon signal is the synchronous transmission-reception pulse beacon, that the first working mode is an interwell measurement communication and data-collection mode, and the second working mode is a ground communication mode.

10. The system according to claim 8, characterized in that the downhole transmitter or the downhole receiver is further configured to determine, when the type of the current beacon signal is the synchronous communication pulse beacon, that the first working mode is the ground communication mode, and the second working mode is the interwell measurement communication and data-collection mode.

11. The system according to claim 8, characterized in that the downhole transmitter or the downhole receiver is further configured to determine, according to a current counting result and in combination with numbers of synchronous transmission, reception and communication for different functional phases, a real-time functional mode of the current downhole device, based on which the type of the current basic beacon signal is determined.

12. The system according to claim 8, characterized in that the central station and each satellite station are configured to complete preparation procedure for communication collaboration in the interwell logging according to the following steps:
generating, by the ground receiver in the central station, the basic beacon signal required for the interwell logging, and actuating, by the ground transmitter, the mobile base station and the central terminal;
sending, by the ground transmitter, a first type of broadcast information for notifying each satellite station to prepare for multiwell logging through the mobile base station and the central terminal, and transmitting to the downhole transmitter a first type of notification information representing preparation for starting the interwell measurement communication and data-collection mode, in order to prepare for the multiwell logging;
completing preparation by the downhole transmitter, and notifying the ground transmitter, waiting for feedback information from each receiving well;
obtaining and decoding, by each ground receiver, the first type of broadcast information based on the basic beacon signal generated independent of the ground receiver of the central station in advance, and transmitting to the downhole receiver the notification information representing preparation for starting the interwell measurement communication and data-collection mode, in order to prepare for the multiwell logging;
completing preparation by each downhole receiver, and notifying the ground receiver; and
transmitting, by each ground receiver, to the ground transmitter the feedback information representing that the current receiving well has completed the preparation for the multiwell logging in a time-sharing manner, in order to start measurement operation of the communication collaboration in the interwell logging.

13. The system according to claim 8, characterized in that the central station and each satellite station are configured to complete the measurement operation of the communication collaboration in the interwell logging according to the following steps:
sending, by the ground transmitter, a second type of broadcast information notifying each satellite station of starting reception operation in the interwell measurement through the mobile base station and the central terminal, and transmitting to the downhole transmitter a second type of notification information representing a start of transmission operation in the interwell measurement;
starting, by the downhole transmitter, transmission, collection and communication operations relating to the communication and control of the transmitting well in the interwell measurement;
obtaining and decoding, by each ground receiver, the second type of broadcast information based on the basic beacon signal generated independent of the ground receiver of the central station in advance, and transmitting to the downhole receiver notification information representing a start of the reception operation in the interwell measurement; and
starting, by each downhole receiver, reception, collection, data processing and communication operations relating to the communication and control of the receiving well in the interwell measurement, in order to complete multiwell measurement of all wells.

14. The system according to claim 8, characterized in that the central station and each satellite station are configured to stop the measurement operation of the communication collaboration in the interwell logging according to the following steps:
sending, by the ground transmitter, a third type of broadcast notifying each satellite station to stop the measurement operation through the mobile base station and the central terminal after completing the multiwell measurement of all wells, and transmitting to the downhole transmitter a third type of notification information representing a completion of transmission;
stopping the transmission of the downhole transmitter, and notifying the ground transmitter;
receiving and decoding, by each ground receiver, the third type of broadcast based on the basic beacon signal generated independent of the ground receiver of the central station in advance, and transmitting to the downhole receiver the notification information representing the stop of the measurement operation; and
stopping the reception of each downhole receiver, and notifying the ground receiver after the reception is completed.

15. The system according to claim 8, characterized in that the broadcast information includes transmission address, reception address, beacon type and transmission frequency, wherein the beacon type includes alignment mark, transmission preparation, completion of transmission preparation, transmitting well measurement, completion of logging transmission, reception preparation, completion of reception preparation, receiving well measurement and completion of logging reception.

16. The system according to claim 1, characterized in that the system further comprises an imaging device connected to the ground transmitter and each ground receiver, and configured to obtain logging transmission data and logging reception data for each receiving well, based on which a three-dimensional imaging model for interwell measurement is constructed.

17. The system according to claim 16, characterized in that the imaging device is further configured to convert the logging transmission data and the logging reception data into a logging data matrix, based on which two-dimensional imaging calculation is performed for each receiving well, in order to obtain the three-dimensional imaging model for interwell measurement after interpolation on calculation results.

18. The system according to claim 17, characterized in that the imaging device is further configured to perform, according to two-dimensional profile resistivity distribution data of the receiving well, global and local electromagnetic induction calculation, and compare calculation results with the logging data matrix, in order to determine whether the two-dimensional imaging calculation is completed.

19. The system according to claim 16, characterized in that the imaging device is arranged in the central station or any one of the satellite stations.
